(19) United States
(12) Patent Application Publication
(10) Pub. No.: US 2026/0341179 A1
(43) Pub. Date: Oct. 29, 2026

(54) METHODS TO ASSIST VERBAL COMMUNICATION FOR BOTH LISTENERS AND SPEAKERS

(71) Applicant: Hiroki SATO, Copenhagen (DK)

(72) Inventor: Hiroki SATO, Copenhagen (DK)

(21) Appl. No.: 19/684,538

(22) Filed: May 21, 2026

Related U.S. Application Data
(63) Continuation of application No. 17/909,622, filed on Mar. 4, 2020, now Pat. No. 12,646,421.

(51) Int. Cl. G09B 21/04; H04R 29/00

(52) U.S. Cl. CPC G09B 21/04; H04R 29/004; H04R 29/008

(57) ABSTRACT

Methods implemented in a system utilizing computing programs for a speaker and a listener in conversation are provided. Aspects include (i) a reminder provisioner for a speaker which is triggered according to speed, pitch or volume of the speaker's speech, (ii) a speech training provisioner for a speaker, and (iii) an application which records and plays back difficult conversation to understand.

### BACKGROUND

Communication between hard-of-hearing people and normal hearing people can often be clunky and cause stress and frustration to both parties especially when something has to be repeated in the conversation.

While the burden in the communication should be shared by both people with hearing difficulty (as defined below) and normal hearing people, recent technological advancement seems to focus on developing surrounding ‘hearing strategy’, but not ‘speaking strategy’. Here, it is possible to look at problem areas from the perspectives of both listeners and speakers.

For speakers, it is practically impossible to fully understand each listener's hearing difficulty as everyone hears differently. Speakers may not know how to speak properly or how their speech is understood by listeners. Also, even when people are aware of the necessity to speak more clearly in talking with a person with hearing difficulty such as hard-of-hearing person, people start to speak less clearly as conversation goes along.

From a listener's perspective, it is considered impolite in some culture to ask for repetition multiple times. Also, it becomes even more difficult to understand and ask for repetition in conversation where there are multiple people speaking.

### SUMMARY

Verbal communication assisting technique implementations described herein generally assist people with hearing difficulty and people who talk with them. People with hearing difficulty, as used herein, include people with less capability in listening to conversation due to physical constrain such as far distance and obstacle, people who are not proficient enough to hear and understand in the language of the conversation or people with hearing device/technology including hearing aid, cochlear implant, born anchored hearing aid and auditory brainstem implant. The invention comprises 3 functions of a system implemented by computing programs. Firstly, the system enables a listener to let a speaker know the fact that the speaker's speech is difficult to understand by the system on behalf of the listener by evaluating speed, pitch and volume of the speech. Secondly, the system helps speakers to speak in a proper way by giving them feedback, herein the users include people with hearing impairment such as the one having sensorineural hearing loss, who could have trouble understanding how to speak. Thirdly, the system records conversation and enables user to play back or save the audio data which is difficult to understand so that users can understand the missed conversation immediately or later.

### DESCRIPTION OF THE DRAWINGS

FIG. 1 is a diagram illustrating one implementation, in simplified form, of a system framework for realizing the method of verbal communication for both a speaker and a listener in conversation;

FIG. 2 depicts a flow diagram of an exemplary implementation, in simplified form, of a process for providing reminders for speakers based on data evaluation of speech (Component 1);

FIG. 3 depicts a flow diagram of an exemplary implementation, in simplified form, of a process for helping speakers understand how to speak properly or naturally by visualizing affecting matters (Component 2); and

FIG. 4 depicts a flow diagram of an exemplary implementation, in simplified form, of a process for recording and playing back audio data of a difficult conversation part (Component 3).

### DETAILED DESCRIPTION

In the following description of verbal communication assisting technique implementations reference is made to the accompanying drawings which form a part hereof, and in which are shown, by way of illustration, specific implementations in which the verbal communication assisting technique can be practiced. It is understood that other implementations can be utilized and structural changes can be made without departing from the scope of the verbal communication assisting technique implementations.

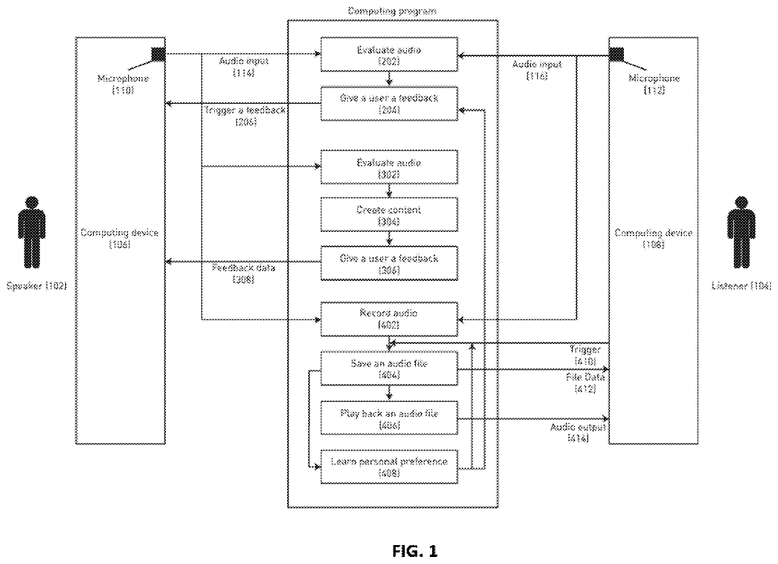

FIG. 1 illustrates one implementation, in simplified form, of a system framework which comprises of multiple components of computing programs, which function independently and also dependently with each other that shares the same database in the system.

### Component 1

The system enables a listener (104) to let a speaker (102) know the fact that the speaker's speech is difficult to understand by the system on behalf of the listener by evaluating speed, pitch and volume of the speech.

For having input, the system is operable with any type of end-user computing device (106, 108) which has a microphone (110, 112) such as a mobile phone, a portable computer, a wearable device (Apple Watch, Fitbit or Galaxy Watch among others) or a hearing device for hard-of-hearing people such as hearing aid and cochlear implant. Upon receiving audio input (114, 116) from the microphone, a computing program in the system evaluates factors of the speech (202) as below:
Speech speed: voice data is translated into text after processing the data through transcription (audio-to-text) tool (such as Javascript SpeechRecognition API) and then the length of the text divided by the duration of speech calculates character/word per second, which can be used as a metric to evaluate the speed of speech.
Volume: voice data is translated into numeric value through a computing program such as sound volume detection program in p5.js library in JavaScript.
Pitch: voice data is translated into numeric value through a computing program such as pitch detection program in ml5.js library (CREPE) in JavaScript.

Each value is evaluated whether it is within range of minimum and maximum value and according to the evaluation, a feedback to a speaker (102) is triggered in the system (206).

In an example, the preset value for threshold values (minimum/maximum) is below, which can be configured by the user:
Speech speed (character per second): In an example of English, 3 characters per second is set as the maximum value and no value is set for minimum value.
Volume: 45 dB for minimum value and 65 dB for maximum value.
Pitch: The duration of voice whose pitch range is within 1% has to be less than 30% (maximum value). In speech-language pathology, speaking with rich tone (rich change of pitch) is considered easy for hard-of-hearing people to understand

The configuration of the threshold value can be done manually by the user, or automatically by the system which sets preset value of normally difficult sound to understand, or learns each user's hearing preference/capability from the audio data labeled as difficult as later described in Component 3.

Upon receiving trigger information by said evaluation, the system gives feedback (204) in such ways as below:
The system gives speakers a haptic feedback through a wristband with a vibrator, a mobile phone or wearable devices (such as Apple Watch, FitBit or Galaxy Watch) which can be programmed to give vibration to user.
The system gives speakers a visual feedback by showing numeric information or graphical representation on speech speed, pitch or volume through screen or user interface computing devices have, which include mobile phone, tablets or wearable devices among others.
The system gives speakers an aural feedback by playing sound by a loudspeaker equipped in said computing devices.

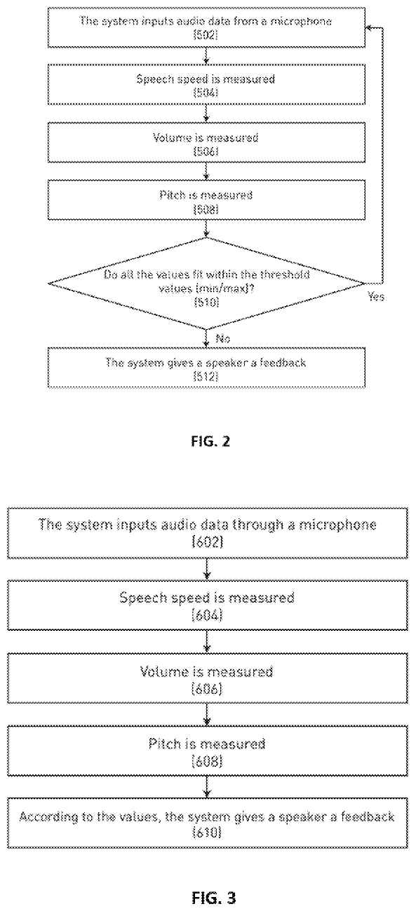

FIG. 2 is a flow diagram of an exemplary implementation, in simplified form, of a process for providing reminders for speakers based on data evaluation of speech. Upon receiving audio input from a microphone (502), the system measure/calculate speed (504), volume (506) and pitch (508) of the speech in said ways, and if either of the values does not fit in threshold values (minimum/max) (510), the system gives a speaker (102) a feedback in said ways (512).

### Component 2

Referring again to FIG. 1, the system visualizes pitch, speed or volume of the speech and gives a clue for a speaker (102) to understand how to speak properly or naturally so that listeners can easily understand. Especially for people having sensorineural hearing loss who could not understand the way of changing tone (pitch) of voice or speaking naturally, the visualization of pitch could be beneficial.

For having input, same as in Component 1, the system is operable with any type of end-user computing device (106, 108) which has a microphone (110, 112) such as a mobile phone, a portable computer, a wearable device (Apple Watch, Fitbit or Galaxy Watch among others) or a hearing device for hard-of-hearing people such as hearing aid and cochlear implant.

Upon receiving audio data through the microphone (114), a computing program in the system evaluates factors of the speech as below (302):
Speech speed: voice data is translated into text after processing the data through transcription (audio-to-text) tool (such as Javascript SpeechRecognition API) and then the length of the text divided by the duration of speech calculates character/word per second, which can be used as a metric to evaluate the speed of speech.
Volume: voice data is translated into numeric value through a computing program such as volume detection program in p5.js library in JavaScript.
Pitch: voice data is translated into numeric value through a computing program such as pitch detection program in ml5.js library (CREPE) in JavaScript.

According to the value measured and calculated in said ways, a computing program creates content (304) such as charts/text/numeric information or graphical object in a browser program such as Google Chrome or FireFox (306, 308). For a user test, it is considered effective to interactively control the size of a graphical object by the volume of voice or surrounding sounds, and control its color by the pitch of voice.

The system can also have a gamification element utilizing graphical object representing speaker's speaking way by preparing a set of rules or a target line to attract more interest from users such as hard-of-hearing children.

The system can further have a speech training/coaching element advising users to change or keep their way of speaking according to evaluation.

FIG. 3 is a flow diagram of an exemplary implementation, in simplified form, of a process for helping speakers understand how to speak properly or naturally by visualizing aspects of speech. Upon receiving audio input from a microphone (602), the system measure/calculate speed (604), volume (606) and pitch (608) of the speech in the said way and the system gives a speaker a feedback (610) in said ways, such as showing a graphical object in a screen.

### Component 3

Referring again to FIG. 1, the system enables a user to record the conversation and play back audio data of a difficult conversation part which is classified by a user or by the system.

People with hearing difficulty can suffer understanding a sentence by missing one or more words. Even if what they missed is just a few words, they could find it hard and stressful to always ask for repeating. As a solution for such difficulty, the system lets a listener (104) understand missed conversation part by herself/himself.

For having input, same as in Component 1, the system is operable with any type of end-user computing device (106, 108) which has a microphone (110, 112) such as a mobile phone, a portable computer, a wearable device (Apple Watch, Fitbit or Galaxy Watch among others) or a hearing device for hard-of-hearing people such as hearing aid and cochlear implant.

In prior to use of this technology implementation, it should be agreed on recording conversation among participants in the conversation.

Upon receiving audio input (114, 116) through a microphone, a computing program in the system records (402) and divides the audio data in multiple small blocks. The system can record and upload audio blocks to a server through a computing program such as Recorder. js in JavaScript.

In conversation, when a listener finds it hard to hear, she/he can trigger the system (410) to save (404) and play back (406) the recent audio data which is short enough to comfortably listen back (414). In a user testing, 10 seconds was considered effective for the duration of the audio data to be played back, but a user can also change the duration of a play back. Also, rather than playing back the audio right away, a user can save/mark the difficult audio and play it back later (412).

The playing back/marking timing can also be triggered automatically by the system. The system can classify the audio data a user previously played back as a difficult sound and understand a user's personal hearing capability/preference through a machine learning process (408).

When playing back, a user can change the speed, volume or pitch of the conversation so that it is easier for the user to understand.

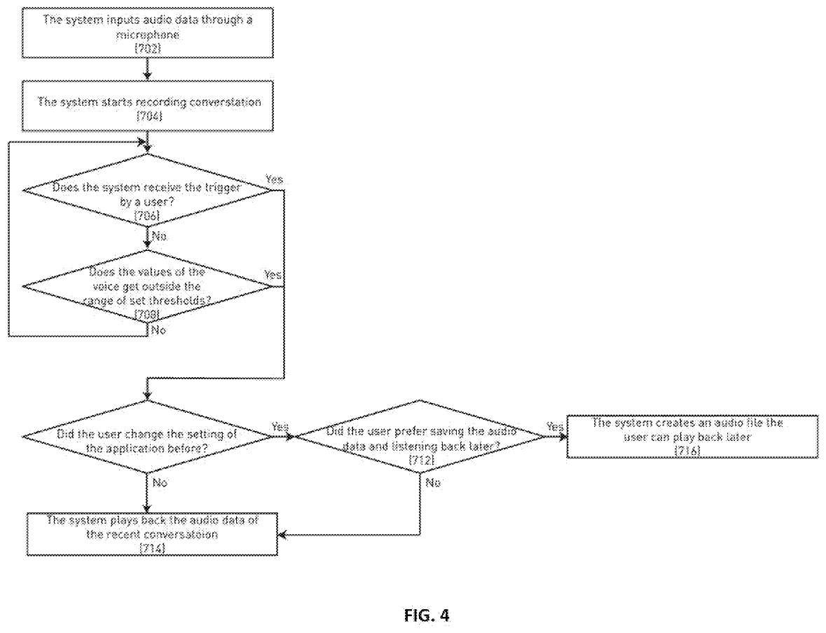

FIG. 4 is a flow diagram of an exemplary implementation, in simplified form, of a process for recording and playing back audio data of a difficult conversation part. Upon receiving audio input from a microphone (702), the system starts recording conversation (704), and if a user triggers the system (706) or the values of the voice get outside the range of set thresholds (708), the system sets out to give a feedback. If a user has not changed setting in the application (710), the system immediately plays back the audio data of recent conversation (714). If a user has changed setting in the application (710) and if the user prefers saving the audio data and listening back later, the user can later play back an audio file the system creates (716).

1. A system for assisting verbal communication between a speaker and a listener during a conversation, the system comprising:
a computing device having one or more microphones configured to receive audio data corresponding to speech of the speaker;
one or more computing programs in connection with the computing device; and
one or more electronic devices configured to provide feedback to the speaker, wherein the one or more computing programs are configured to:
extract one or more speech-related features from the audio data, the one or more speech-related features including at least one of speech speed, pitch or frequency and a transition thereof, or volume;
determine, based on the one or more speech-related features and at least one threshold value, that the speech is difficult for the listener to understand;
and cause feedback to be provided to the speaker during the conversation in response to the determination.

2. The system of claim 1, wherein the at least one threshold value comprises a minimum value and a maximum value for at least one of speech speed, pitch, or volume.

3. The system of claim 1, wherein the at least one threshold value is updated based on data provided by the listener to the system.

4. The system of claim 1, wherein threshold values used to determine when to provide feedback are configured manually by a user, are preset by the system for sound that is difficult to understand, or are personalized according to a hearing capability of the listener by utilizing previously recorded audio data labeled as difficult and training the system, and wherein, before user-specific threshold adaptation is available, the at least one threshold value comprises a preset threshold value used to determine that the speech is difficult for the listener to understand.

5. The system of claim 4, wherein the system learns the listener's hearing preference or hearing capability from the audio data labeled as difficult and automatically adjusts the at least one threshold value.

6. The system of claim 1, wherein the feedback comprises at least one of haptic feedback, visual feedback, or aural feedback.

7. The system of claim 6, wherein the feedback is used for training speech of the speaker to improve understandability to the listener, and wherein the visual feedback comprises at least one of charts, text, numeric information, or a graphical representation associated with speech speed, pitch, or volume.

8. The system of claim 7, wherein the graphical representation changes color, size, or shape according to at least one of pitch, volume, or speech speed, or comprises a gamification element or a coaching element that advises the speaker to change or keep a way of speaking according to the determination.

9. A system for assisting a listener in a conversation with a speaker, the system comprising:
a computing device having one or more microphones configured to receive audio input of the conversation between the speaker and the listener; and
one or more computing programs in connection with the computing device, wherein the one or more computing programs are configured to:
record the conversation and divide the audio input into a plurality of small blocks;
identify a difficult conversation part that is difficult for the listener to understand in response to a trigger from the listener or an automatic determination that one or more speech-related features associated with the audio input are outside a range of set thresholds; and
cause recent audio data corresponding to the difficult conversation part to be played back or saved for later playback.

10. The system of claim 9, wherein, before user-specific threshold adaptation is available for the listener, the range of set thresholds comprises one or more preset threshold values used to make the automatic determination, and wherein the one or more computing programs are further configured to generate, for each of the plurality of small blocks, at least one speech-related feature, compare the at least one speech-related feature with the range of set thresholds, and make the automatic determination based on one or more generated speech-related features being outside the range of set thresholds.

11. The system of claim 9, wherein each small block has a duration short enough to allow the listener to comfortably listen back to the audio data, and wherein a duration of the recent audio data to be played back or saved comprises a preset value by the system ranging between 0 seconds and 30 seconds or a customized value configured by the listener.

12. The system of claim 9, wherein the plurality of small blocks are uploaded to or stored on a server, and the server allows the listener to play back or save the audio data corresponding to the difficult conversation part.

13. The system of claim 9, wherein the trigger from the listener comprises operation of a physical or graphical control to indicate that the difficult conversation part was not understood, and wherein, when the listener has not changed a setting in an application, the recent audio data is played back immediately, and when the listener has changed the setting to prefer later playback, the recent audio data is saved as an audio file for later playback.

14. The system of claim 9, wherein the one or more computing programs are further configured to change at least one of speed, volume, or pitch of the recent audio data during playback so that the listener understands better.

15. The system of claim 9, wherein the system classifies audio data previously played back or saved by the listener as difficult audio data, learns the listener's personal hearing capability or preference from the difficult audio data, and adjusts the range of set thresholds based on the learned personal hearing capability or preference.

16. A computer-implemented method for assisting verbal communication between a speaker and a listener during a conversation, the method comprising:
receiving, by a computing device having one or more microphones, audio data corresponding to speech of the speaker;
extracting, by one or more computing programs executing on or in connection with the computing device, one or more speech-related features from the audio data, the one or more speech-related features including at least one of speech speed, pitch or frequency and a transition thereof, or volume;
determining, based on the one or more speech-related features and at least one threshold value, that the speech is difficult for the listener to understand; and
causing an electronic device to provide feedback to the speaker during the conversation in response to the determination.

17. The method of claim 16, wherein the at least one threshold value comprises a minimum value and a maximum value for at least one of speech speed, pitch, or volume.

18. The method of claim 16, wherein the at least one threshold value is updated based on data provided by the listener to the system.

19. The method of claim 16, wherein threshold values used to determine when to provide feedback are configured manually by a user, are preset by the system for sound that is difficult to understand, or are personalized according to a hearing capability of the listener by utilizing previously recorded audio data labeled as difficult and training the system, and wherein, before user-specific threshold adaptation is available, the at least one threshold value comprises a preset threshold value used to determine that the speech is difficult for the listener to understand, and the system learns the listener's hearing preference or hearing capability from the audio data labeled as difficult and automatically adjusts the at least one threshold value.

20. The method of claim 16, wherein the feedback comprises at least one of haptic feedback, visual feedback, or aural feedback, wherein the feedback is used for training speech of the speaker to improve understandability to the listener, and wherein the visual feedback comprises at least one of charts, text, numeric information, or a graphical representation associated with speech speed, pitch, or volume, and wherein the graphical representation changes color, size, or shape according to at least one of pitch, volume, or speech speed, or comprises a gamification element or a coaching element that advises the speaker to change or keep a way of speaking according to the determination.

21. The system of claim 6, wherein the computing device comprises at least one of a mobile phone, portable computer, wearable device, or hearing device, and wherein the haptic feedback is provided by vibration through a wristband, mobile phone, or wearable device, the visual feedback is provided by a screen or user interface, and the aural feedback is provided by a speaker or audio output device.
